(19) United States
(12) Patent Application Publication
(10) Pub. No.: US 2009/0172300 A1
(43) Pub. Date: Jul. 2, 2009

(54) Device and method for creating a distributed virtual hard disk on networked workstations

(76) Inventor: Holger Busch, Timmendorfer Strand (DE)

Correspondence Address: Nixon Peabody LLP, 200 Page Mill Road, Suite 200, Palo Alto, CA, 94306, US

(21) Appl. No.: 12/374,049

(22) PCT Filed: Jun. 13, 2007
(86) PCT No.: PCT/EP2007/054790

§ 371 Date: Feb. 16, 2009

(30) Foreign Application Priority Data
Jul. 17, 2006 (DE) 102006033285.7

(51) Int. Cl. G06F 12/02

(52) U.S. Cl. 711/147; 711/E12.013

(57) ABSTRACT

Method and device for providing a virtual drive on a workstation PC which is connected via a network to other workstation PCs, encompassing a driver which makes available the virtual drive and carries out the following steps:
Administering a mapping table from which it is apparent which data is stored on which of the other workstation PCs,
During reading of the data, checking the table and requesting data from the other workstation PC which is stored in the table,
During writing of the data, checking the table to find a suitable entry in the table, sending the data to one of the other workstation PCs and entering a reference in the table on the other workstation PC which has acquired the data.

The invention relates to a method and a device for providing a hard-disc drive on a computer, in particular the invention relates to a storage drive which is partitioned.

### FIELD OF THE INVENTION

The continuous increase in available computer power and storage capacity on workstation PCs makes it possible to use these “free” capacities for tasks other than carrying out interactive applications for the user.

In particular, the introduction of workstation PCs with several processor cores or several individual processors makes it possible to use these capacities without the user experiencing impairment as a result.

It is advantageous for the software described here that the workstation PCs are networked with one another with a network of high band width.

### OVERVIEW OF THE INVENTION

The object of the present invention is to provide a method and a device which make it possible that the hard-disc space on a plurality of PCs can be used in a simple and uniform manner.

This object is achieved by an invention with the features of the independent claims.

In order to facilitate understanding of the invention, several definitions of terms are set out below.

A workstation PC refers to a computer on which an individual user normally works interactively. In contrast to this, a server is a computer on which either no interactive work is performed or which is used in parallel by several users. Due to the particular power and flexibility of computers and operating systems, the transition between a server and a workstation PC is, however, often fluid. In the Windows family, a workstation PC can also release a hard-disc drive or a directory such that it can act as a server. The workstation PCs described here can thus also act as servers.

A drive describes in this context a storage area for permanent storage of data to which a physical memory is assigned.

This physical memory is generally referred to as a partition. Under the operating systems of the Windows family, a letter is used for the purpose of addressing. In the case of other operating systems, the partition can also be represented as a part of a directory. It is thus not apparent to the user when he accesses a different hard disc or partition.

A virtual drive is a possibility for permanent storage of data. The storage area of a virtual drive is mapped onto an entire drive or a part of a drive. In particular, under an operating system of the Windows family, a virtual drive could be mapped into a file (part of a drive) or a partition (entire drive). A virtual drive appears to the user as a physical drive, but can in fact be a part of a physical drive, or several physical drives or other types of storage media such as RAM, Flash, etc.

A partitioned virtual drive is a possibility for permanent storage of data in a virtual drive. The storage area of the virtual drive is partitioned via various workstation PCs in this case to an entire drive or a part of a drive. Despite the partitioning to various drives, use as a coherent storage area is possible. This can be achieved transparently for the user.

The invention has the following general properties.

The partitioned virtual drive should be capable of running under an operating system of the Windows family. This is achieved by implementation as drivers. Use in other operating systems such as LINUX or UNIX is naturally also possible. Similar concepts are used here.

The invention makes it possible to install one or more virtual partitioned drives on the workstation PCs.

The partitioned virtual drives can be used by users under a drive letter just like other drives.

Administration and data partitioning for a partitioned virtual drive are carried out in a transparent manner for the user since the virtual drive appears as a real drive for the operating system due to the architecture of the driver.

File rights administration of the respectively used operating system functions without restrictions even within the partitioned virtual drive.

The storage area of the partitioned virtual drive is implemented on the respective workstation PCs within a file (container file).

The access rights to the files which serve as containers for the partitioned virtual drive are administered by means of the file rights administration of the respectively used operating system.

A link of the rights administration for files within the partitioned virtual drive to an ADS (Active Directory Service) is possible.

Installation and administration of the partitioned virtual drives on all workstation PCs are carried out via an administration system (administration tool).

The following particular properties are additionally implemented:

### Failure Safety

Data storage in the container files can be carried out redundantly. I.e. it is possible to adjust via the administration tool how often the data of a partitioned virtual drive is held as a copy. Setting a simple redundancy means that, for each container file, a copy is held on a different workstation PC. The redundancy can be adjusted between 1—no redundancy—and n—n-times redundancy.

In the case of redundant data storage in the container files with a redundancy of at least two, failure safety in the event of a disaster can be achieved. Events which prevent further use of a site are regarded here as disasters against which protection is provided. The prerequisite for this is therefore at least one further site. Groups of workstation PCs can be defined via the administration tool. The redundancy can be set such that a copy of the container file is always held in one group and the second copy in a different group. If the workstation PCs of one site are contained in the first group and the workstation PCs of a different site are contained in the second group, failure safety in the event of a disaster in the sense defined above is achieved.

One prerequisite is that the buildings are sufficiently far from one another such that it can be expected that an event which prevents further use of one site does not simultaneously affect the second site.

The access speed depends on two factors. On the one hand, optimum partitioning of the data in the container files and, on the other hand, the transmission time in the network.

The network structure can be detected via the admin tool and is stored within the partitioned virtual drive.

Data storage within the container files takes place in blocks in a similar manner to data storage on physical drives. A recording takes place of the unique identifier of workstation PCs, which access these blocks, within the container file.

Optimisations are carried out cyclically on the basis of this information. During an optimisation process, a statistical evaluation of the access frequency to each block is carried out. The storage location of the blocks is subsequently adapted with the help of the stored network structure such that an optimum access speed can be expected.

As a result of the stored network structure, the set of workstation PCs can be subdivided into the following subsets:
Subsets T0ᵢ comprise in each case a single workstation PC. There are as many subsets T0ᵢ as workstation PCs in the partitioned virtual drive.
Subsets T1ⱼ comprise in each case the workstation PCs in a physical network segment. There are as many subsets T1ⱼ as physical network segments.
Subsets T2ₖ are formed by the workstation PCs from in each case two adjacent network segments with a distance of 1. In other words, a subset T3ₖ comprises two subsets T1ⱼ.
Subsets T3ₗ are formed by the workstation PCs from in each case three adjacent network segments with a distance of 2. A subset T3ₖ comprises three subsets T1ⱼ. A subset T3ₖ comprises two subsets T2ₖ which however jointly contain only three different network segments.

Therefore, it generally applies for all subsets Yqₙ for q greater than 0 that they are formed from the workstation PCs of q adjacent network segments with a distance of q−1.

A network segment encompasses all the workstation PCs which can be reached between one another via the network without network traffic having to be conducted via an active network component.

An active network component is e.g. a router or a switch.

Adjacent network segments with a distance n are network segments in which the network traffic between any two workstation PCs must be conducted through a maximum of n active network components.

In order to determine the optimum storage location for each block, the sum of the accesses from the workstation PCs is calculated for each block from each of subsets Tqₙ. In this case, the value for q will pass from 0 to m. Maximum value m for q can be set via the administration tool since it significantly influences the optimisation period. The number of blocks considered for optimisation and the frequency of optimisation can also be freely adjusted via the administration tool.

Subset Tqₙ with the highest sum of accesses is subsequently ascertained in accordance with the above measurement instructions. Subset Tq−1ᵣ which has the highest sum of accesses to the block is then ascertained again in the next step from all subsets Tq−1ᵣ of subset Tqₙ. This is continued until q=0. In other words, the workstation PC which has the highest access figures of all workstation PCs within T0ᵢ to the block is then ascertained in the last step from this last subset T0ᵢ.

The block is then physically moved to this workstation PC. If several workstation PCs have the same number of accesses in the last considered subset T0ᵢ, the block is thus moved to the workstation PC with the highest free capacity in terms of its share of the partitioned virtual drive.

Should sufficient storage space no longer be present on the selected workstation PC in terms of its share of the partitioned virtual drive, this is excluded from the optimisation process and a new workstation PC is selected in accordance with the above method.

A further element of the invention is the optimisation of power consumption. In the case of power consumption, a differentiation takes place by use of the partitioned virtual drive. If interactive accesses primarily take place, i.e. the users of the workstation PCs use the drive by means of accesses during their working time, additional power consumption is not to be expected (case I).

If the use of the partitioned virtual drive takes place outside the working time of the users of the workstation PCs, we are either dealing with batch operation (case IIa) or a use by users who do not work with the workstation PCs which are used for the partitioned virtual drive, but rather with other workstation PCs (case IIb). In this case, additional power consumption can arise in the case of the workstation PCs of the partitioned virtual drive.

In order to optimise power consumption, the data which is primarily used in cases II can be identified. This is carried out by additional recording of the access time together with recording of the unique identifiers of workstation PCs, which access these blocks, within the container file.

The blocks which are primarily used in cases II are identified on the basis of the access times.

Separate groups can be defined for these blocks by means of the admin tool. These groups form a subset of all the workstation PCs which are used for the partitioned virtual drive. Not all of the workstation PCs thus have to be active in case II. Using the operating system's own power saving functions, it is possible that all other workstation PCs outside the groups which were defined for case II reduce their power consumption to a minimum.

In one possible embodiment, the invention comprises three modules:
1) A kernel driver for providing a virtual drive
2) Server software for providing a partitioned virtual drive
3) Administration software (administration tool) for configuration of the partitioned virtual drives. The administration software does not perform any function during operation of partitioned virtual drives, but rather only serves to easily adjust the local configurations of the server software (see 2) for a central location.

A further aspect is versioning. In this case, data storage in the container files can take place with various version statuses. Additional versions with an older date can exist alongside a current version for a block within a container file. Version copies are created on the basis of events or time or interactively. One possible embodiment of the event-based creation of version copies is the creation of a version copy of a block as soon as data is written in the relevant block.

The older version copies can no longer be changed by the user. The user can be provided again with historical statuses via the admin tool and older version copies can again be released for overwriting.

The versioning described here is used to achieve the following functions.
a) Producing one or more backups, which are available online, at freely selectable times which can be made available to the user again as required.
b) Producing redundant data storage in which the redundant copies are not synchronously present in both container files, but rather the redundant copy is created on the basis of a version copy initiated at a specific time.
c) Producing a partitioned virtual drive which behaves like a WORM memory in which a version copy of the relevant block with the status before writing access is created on an event basis in the case of each write access.
d) Producing consistent copies of a partitioned virtual drive on other storage systems in which a version copy which is initiated at a specific time is transferred to the other storage system.

### BRIEF DESCRIPTION OF THE FIGURES

The figures are described briefly below, wherein the following description of the preferred embodiments refers to the figures. The figures and the preferred embodiments do not represent any restriction of the present invention and should only serve the function of possible examples:

FIG. 1 shows the structure of the virtual drive which is stored on a physical drive, the virtual drive comprising several parts;

FIG. 2 shows the structure of the virtual drive from FIG. 1, the data of the virtual drive being stored in container files on the physical drive of the workstation PCs;

FIG. 3 shows the redundant storage of data on physical drives in container files, each container file being present in duplicate on in each case a different PC which is preferably arranged in a different building;

FIG. 4 shows the constellation according to FIG. 3, the computers being arranged in each case in a building one and building two;

FIG. 5 shows the hierarchy or the layers of the software which is used for the method according to the invention;

FIGS. 6a, 6b, shows the progression of the optimisation process; Description of the preferred embodiments:

FIG. 1 shows 1 to n workstation PCs which are connected to one another via a network and which in each case have a physical drive, such as a hard disc, a flash memory or a CD-ROM/RW (this list is not exclusive). The workstation PCs are connected to one another by LAN, WLAN or WAN network. A part for a virtual drive is reserved on each of the physical drives. Each of the workstation PCs thus represents a part of the virtual drive. The kernel driver for the virtual drive is then installed on each of the workstation PCs to which the virtual drive is made available, which kernel driver in turn brings together the individual parts of the virtual drive which are stored on different workstation PCs to form one overall drive. The kernel driver has, in the preferred embodiment, a table (e.g. implemented as a hash table) in which it is recorded on which of the workstation PCs which data is stored. In the preferred embodiment, this is carried out at block level. It is, however, also possible to carry this out at a different level such as e.g. the file level.

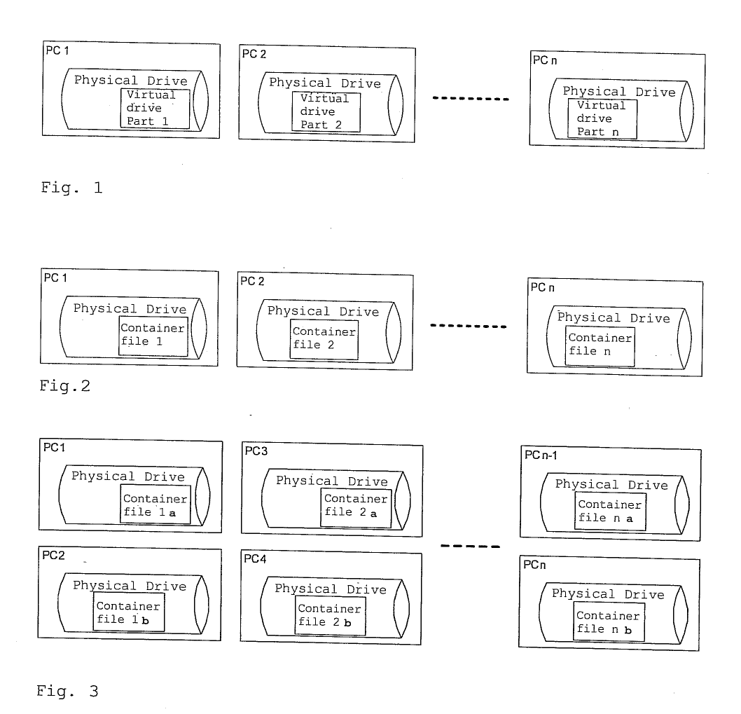

FIG. 2 shows a variation of FIG. 1 in which the virtual drive is stored in a container file. Each workstation PC has a small server programme which is responsible for access to the container file. The container file can thus be administered with the help of the operating system functions such that unauthorised access to this file is prevented. It can thus be ensured that only the authorised server programme can access this file.

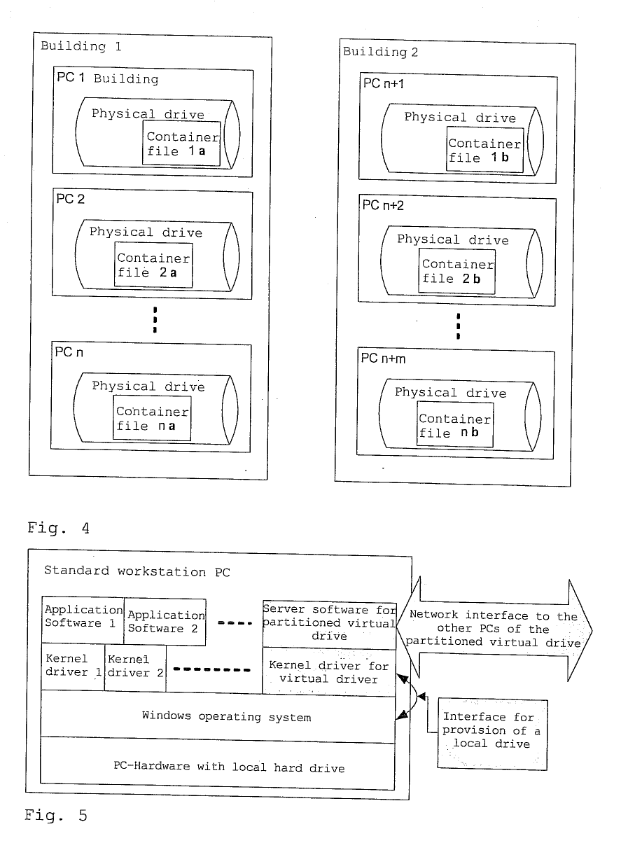

FIG. 3 shows a redundant approach in which each container file is present in duplicate. As a result, this involves a Raid-I solution (Redundant Array of inexpensive Disks). A duel or x-times Raid 1 solution can also be configured. However, other Raid solutions such as e.g. 3, 5, 6, 10 are also conceivable. In this case, it should in particular be noted that Raid solutions are also conceivable which have several parity bits such that one or more container files can fail. Such solutions are often referred to as Raid 6 solutions. The kernel driver for the virtual drive has in this case several references to different computers in order to load or write the block whose address is stored behind this for the block from these computers. In the case of a Raid 3, 5 or 6, the missing information is reproduced from the other information which is still available on the basis of the XOR link. The workstation PCs have server software to implement the method, which software, on the one hand, controls access to the container file and, on the other hand, responds to queries of the kernel driver. The kernel driver loads directly on the operating system such that the presence of a physical drive is detected for the applications (see FIG. 5). Details of this are described with regard to FIG. 5.

FIG. 4 shows the approach of FIG. 3 for two sites. The property of failure safety in the event of a disaster can also be achieved with more than two sites.

FIG. 5 shows the fundamental structure of the invention on a workstation PC. The parts highlighted in grey are a component of the software for the partitioned virtual drives. The administration software can be installed on any workstation PC, it serves to configure the components. In principle, the kernel driver for the virtual drive must be installed on a PC. The server software for the virtual drive which receives and answers the queries of the kernel driver is required on the other workstation PCs. A new drive is thus, for example, displayed on a workstation PC under a new letter, wherein the kernel driver performs the mapping of the blocks onto the container file. A query to the server software for the partitioned virtual drive is then sent via the network to one of the other workstation PCs which then loads the block from the container file and sends it back to the PC with the kernel driver. The kernel driver in turn makes the block available to the application software. Application software is generally the file management system. The kernel driver can be formed such that it is responsible for several virtual drives or there are several drivers in parallel in order to represent several drives.

The administration software administers, on the one hand, the kernel drivers and, on the other hand, the server software which is installed on the individual workstation PCs. It is defined by means of these which computers are available for the virtual drive and what their capacity is. Moreover, the optimisation processes can be carried out by the administration software.

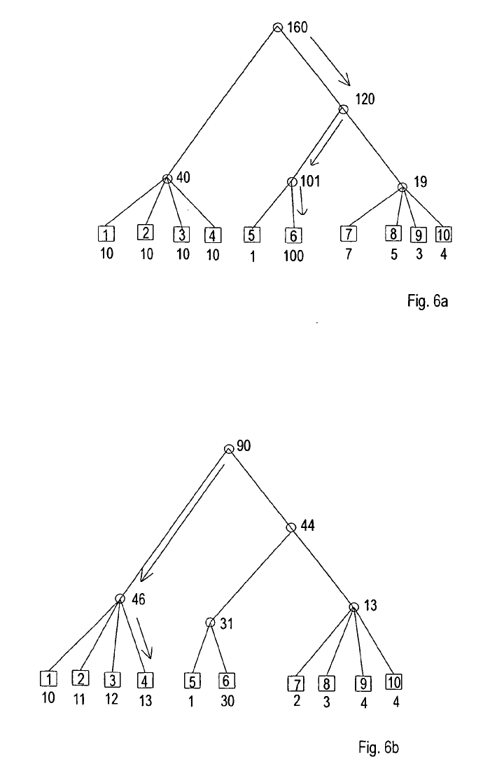

FIG. 6a shows the progression of the optimisation process in a PC network with a tree structure for a block. In this case, the square boxes represent the PCs which in each case hang in a branch which represents a network segment. In FIG. 6a, a block was accessed 160 times, with 40 accesses originating from the first segment and 120 from the second (this is divided into 101 and 19 for further segments). PC 6 has accessed the block 100 times in total and thus receives the block.

FIG. 6b shows an alternative configuration in which network segment 1 receives the block with 46 accesses even if PC 6 with 30 accesses has the most hits in network segment 2 in absolute terms. However, 46 is greater than 31, as a result of which segment 1 should be taken into account.

1. Method for providing a virtual drive on a workstation PC which is connected via a network to other workstation PCs, encompassing a driver which makes available the virtual drive and carries out the following steps:
Administering a mapping table from which it is apparent which data is stored on which of the other workstation PCs,
During reading of the data, checking the table and requesting data from the other workstation PC which is stored in the table,
During writing of the data, checking the table to find a suitable entry in the table, sending the data to one of the other workstation PCs and entering a reference in the table on the other workstation PC which has acquired the data.

2. Method according to claim 1, wherein the table operates at block level such that information is stored on the other workstation PCs in the network at block level.

3. Method according to claim 1 one or more of the preceding claims, wherein the driver is formed such that one or more virtual partitioned drives are administered on the workstation PC.

4. Method according to claim 1, wherein the virtual drive is detected as a device by applications such that it can be used under the Windows family under a drive letter or is available under LINUX as a block device.

5. Method according to claim 1, wherein server software is installed on the other workstation PCs, the software receives and processes the requests of the driver and downloads the requested data from a local physical drive.

6. Method according to claim 1, wherein the storage area of the partitioned virtual drive is administered on the other workstation PCs within a file (container file).

7. Method according to claim 6, using access rights to the files which serve as containers for the partitioned virtual drive are administered by means of the file rights administration of the respectively used operating system.

8. Method according to claim 1, wherein installation and administration of the partitioned virtual drives on all workstation PCs are carried out via administration software (administration tool) by constructing a connection to the server software and the kernel driver.

9. Method according to claim 1, wherein the data is redundantly stored in container files by additionally storing this data on other workstation PCs.

10. Method according to claim 9, characterised in that redundancy takes place over several locations.

11. Method according to claim 9, wherein groups of workstation PCs are defined such that a copy of the container file is always held in one group and the second copy in a different group.

12. Method according to claim 1, wherein access statistics to the data are administered.

13. Method according to claim 12, wherein optimisations are carried out on the basis of the access statistics, as a result of which the storage of information can shift from one workstation PC to another such that an optimum access speed can be expected.

14. Method according to claim 1, wherein optimisation of power consumption is carried out taking into account the time of use of the information such that data which is used at specific times of the day is only stored on those workstation PCs which have a defined performance profile at these times of the day.

15. Method according to claim 1, characterised in that versioning is used in which the old files or their blocks are not overwritten such that copies of the old files are retained to which access can take place.

16. Method according to claim 15, wherein versioning is used to achieve one or more of the following functions:
Producing backups, which are available online, at freely selectable times which are made available to the user again as required.
Producing redundant data storage in which the redundant copies are not synchronously present in both container files, but rather the redundant copy is created on the basis of a version copy initiated at a specific time.
Producing a partitioned virtual drive which behaves like a WORM memory in which a version copy of the relevant block with the status before writing access is created on an event basis in the case of each write access.
Producing consistent copies of a partitioned virtual drive on other storage systems in which a version copy which is initiated at a specific time is transferred to the other storage system.

18. Device in the form of a workstation PC for providing a virtual drive which is connected via a network connection to other workstation PCs, encompassing a driver which makes available the virtual drive, wherein the driver is formed in combination with a processing unit such that it, in combination with a mapping table from which it is apparent which data is stored on which of the other workstation PCs,
during reading of the data, queries the table in order to call up the data from another workstation PC which is stored in the table,
during writing of the data, queries the table to find a suitable entry in the table, in order to then send the data to one of the other workstation PCs via the network connection and write a reference in the table on the other workstation PC which has acquired the data.

19. Device according to claim 18, wherein the table operates at block level such that information is stored on the other workstation PCs in the network at block level.

20. Device according to claim 18, wherein the driver is formed such that one or more virtual partitioned drives are administered on the workstation PC.

21. Device according to claim 18, wherein the virtual drive is detected as a device by applications such that it can be used under the Windows family under a drive letter or is available under LINUX as a block device.

22. Device according to claim 18, wherein server software is installed on the other workstation PCs, which software is formed such that it receives and processes the requests of the driver and downloads the requested data from a local physical drive.

23. Device according to claim 18, wherein the storage area of the partitioned virtual drive is administered on the other workstation PCs within a file.

24. Device according to claim 18, wherein the access rights to the files which serve as containers for the partitioned virtual drive are administered by means of the file rights administration of the respectively used operating system.

25. Device according to claim 18, wherein means are present which implement administration software which enables installation and administration of the partitioned virtual drives on all workstation PCs by constructing a connection to the server software and the kernel driver.

26. Device according to claims 18, wherein means are present which store the data redundantly in container files by additionally storing this data on other workstation PCs.

27. Device according to claim 26, wherein redundancy takes place over several locations.

28. Device according to claim 26, wherein means are present to define groups of workstation PCs such that a copy of the container file is always held in one group and the second copy in a different group.

29. Device according to claim 27, wherein means are present to administer access statistics to the data.

30. Device according to claim 29, wherein means are present to carry out optimisations on the basis of the access statistics, as a result of which the storage of information can shift from one workstation PC to another such that an optimum access speed can be expected.

31. Device according to claim 18, wherein means are present to allow an optimisation of power consumption to be carried out taking into account the time of use of the information such that data which is used at specific times of the day is only stored on those workstation PCs which have a defined performance profile at these times of the day.

32. Device according to claim 18, wherein means are provided such that versioning is enabled in which the old files or their blocks are not overwritten such that copies of the old files are retained to which access can take place.

33. Device according to claim 32, wherein versioning is used to achieve one or more of the following functions:
Providing backups, which are available online, at freely selectable times which are made available to the user again as required.
Producing redundant data storage in which the redundant copies are not synchronously present in both container files, but rather the redundant copy is created on the basis of a version copy initiated at a specific time.
Producing a partitioned virtual drive which behaves like a WORM memory in which a version copy of the relevant block with the status before writing access is created on an event basis in the case of each write access.
Producing consistent copies of a partitioned virtual drive on other storage systems in which a version copy which is initiated at a specific time is transferred to the other storage system.
